(19) United States
(12) Patent Application Publication
(10) Pub. No.: US 2026/0233809 A1
(43) Pub. Date: Aug. 13, 2026

(54) Self-Deploying Apparatus for Attaching a Lashing to a Container

(71) Applicant: Trendsetter Vulcan Offshore, Inc., Houston, TX (US)

(72) Inventor: James MAHER, Houston, TX (US)

(21) Appl. No.: 19/130,799

(22) PCT Filed: Feb. 13, 2025
(86) PCT No.: PCT/US2025/015831

§ 371 Date: May 16, 2025

Related U.S. Application Data
(60) Provisional application No. 63/553,358, filed on Feb. 14, 2024.

(51) Int. Cl. B63B 25/24; B63B 25/28

(52) U.S. Cl. CPC B63B 25/24; B63B 2025/285

(57) ABSTRACT

A winding apparatus and a tensioning apparatus are used for deploying a lashing on cargo ships and securing shipping containers. The winding apparatus includes a support, a motorized winch, a fastening line, a releasable connector, and electronic circuitry configured to drive the motorized winch. When the support interfaces with an interlocking system of a shipping container, an overhang portion of the support hangs over the shipping container. The tensioning apparatus includes a foundation, a tensioning winch, 2025/175034 a connection line, and a releasable connector. The foundation is coupled to at least one of a lashing bridge or a deck of the cargo ship. In use, the fastening line is payed out fully using the motorized winch, the connection line is coupled to the fastening line using the releasable connectors, and tension is applied to the fastening line and the connection line using the tensioning winch.

### CROSS-REFERENCE TO RELATED APPLICATIONS

This application claims the benefit of priority to U.S. provisional application Ser. No. 63/553,358 filed on Feb. 14, 2024, which is incorporated herein by reference for all and/or any purposes.

### FIELD OF THE INVENTION

This disclosure relates generally to methods and systems for securing shipping containers on a cargo ship. This disclosure relates more particularly to methods and systems for lashing shipping containers that are less dependent on manual labor for being deployed.

### BACKGROUND OF THE INVENTION

Cargo ships can accidentally lose large numbers of shipping containers at sea while sailing through heavy seas. As ships become bigger and shipping containers are stacked higher, the customary lashing system design which has been used for many years cannot provide an acceptable level of restraint. The movement of the upper containers that is caused by the ship's pitch and roll under the influence of waves increases. This movement can destabilize the shipping containers because of the higher acceleration levels of the upper containers.

Examples of known methods and systems for securing shipping containers on a cargo ship are described in the International Application pub. no. WO 2022/169484, published on Aug. 11, 2022, and incorporated herein by reference.

Despite these advances, there is a need in the art for improved methods and systems for securing shipping containers on a cargo ship, which, in particular, may be less dependent on manual labor for being deployed.

### BRIEF DESCRIPTION OF THE DRAWINGS

For a more detailed description of the embodiments of the disclosure, reference will now be made to the accompanying drawings, wherein:

FIG. 1 is a perspective view of a portion of a cargo ship having shipping containers stacked thereon and a system for deploying a lashing on cargo ships and securing the shipping containers, wherein the system includes a winding apparatus and an optional tensioning apparatus;

FIG. 2 is a perspective view of a winding apparatus having an arm illustrated tilted up;

FIG. 3A is a perspective view of the winding apparatus shown in FIG. 2 with the arm illustrated tilted down;

FIG. 3B is another perspective view of the winding apparatus shown in FIG. 2 with the arm illustrated tilted down;

FIG. 4 is a perspective view, partially transparent, of a tensioning apparatus;

FIG. 5 is a perspective view, partially transparent, of a portion of a tensioning winch;

FIG. 6 is a perspective view of an operator standing on one of a lashing bridge or a deck of the cargo ship applying tension to a lashing using a portable power tool connected to a tensioning winch;

FIG. 7 shows a portion of a lashing including a portion of a fastening line, a tension monitor, and a portion of a tensioning line (also referred to herein as a connection line) releasably connected.

### SUMMARY OF INVENTION

In one embodiment, the disclosure provides a winding apparatus for deploying a lashing on cargo ships and securing shipping containers, comprising: a support capable of interfacing with an interlocking system of one or more shipping containers interface with the support at a top level or a bottom level of the support, the top level and the bottom level being parallel, wherein the support includes an overhang portion that is configured to hang over a longitudinal end of the one or more shipping containers when the interlocking system interfaces with the one or more shipping containers, the overhang portion being located between the bottom level and the top level; a motorized winch attached to the overhang portion and located between the bottom level and the top level; a fastening line attached to the motorized winch; electronic circuitry configured to drive the motorized winch for lifting or lowering the fastening line, the electronic circuitry being located between the bottom level and the top level; a releasable connector attached to the fastening line; and optionally an arm rotatively coupled to the overhang portion, the fastening line resting on a movable end of the arm, the arm having a storage orientation wherein the arm is tilted upward such that the releasable connector is located between the bottom level and the top level when the releasable connector is proximal to the movable end of the arm, the arm having a usage orientation wherein the arm is tilted downward.

In another embodiment, the disclosure provides a lashing system for deploying a lashing on cargo ships and securing shipping containers, comprising: a winding apparatus as described above and either of: i) a tensioning apparatus adapted to releasably couple the lashing apparatus to at least one of a lashing bridge or a deck of the cargo ship to apply tension to the fastening line; or ii) rigging equipment previously existing on the cargo ship for applying tension to the fastening line.

In a further embodiment, the disclosure provides a lashing system for deploying a lashing on cargo ships and securing shipping containers, comprising: a winding apparatus including: a support capable of interfacing with an interlocking system of one or more shipping containers, wherein the support includes an overhang portion that is configured to hang over a longitudinal end of the one or more shipping containers when the interlocking system interfaces with the one or more shipping containers; a motorized winch attached to the support; a fastening line attached to the motorized winch; electronic circuitry configured to drive the motorized winch for lifting or lowering the fastening line; a first releasable connector attached to the fastening line; and either of: i) a tensioning apparatus including: a foundation, wherein the foundation is adapted to be coupled to at least one of a lashing bridge or a deck of the cargo ship; a tensioning winch attached to the foundation; a connection line attached to the tensioning winch; a second releasable connector attached to the connection line; wherein the first releasable connector is selectively couplable to the second releasable connector; or ii) rigging equipment previously existing on the cargo ship for applying tension to the fastening line.

In yet a further embodiment, the disclosure provides a method of deploying a lashing on cargo ships and securing shipping containers, comprising: providing a winding apparatus including a support, a motorized winch attached to the support, a fastening line attached to the motorized winch, a first releasable connector attached to the fastening line, and electronic circuitry configured to drive the motorized winch; interfacing the support with an interlocking system of one or more shipping containers, wherein the support includes an overhang portion that is configured to hang over a longitudinal end of the one or more shipping containers when the interlocking system interfaces with the one or more shipping containers; providing a tensioning apparatus including a foundation, a tensioning winch attached to the foundation, a connection line attached to the tensioning winch, and a second releasable connector attached to the connection line; coupling the foundation to at least one of a lashing bridge or a deck of the cargo ship; paying out the fastening line fully; coupling the connection line to the fastening line using the first and second releasable connectors; and applying tension to the fastening line by paying in the connection line with the tensioning winch.

### DETAILED DESCRIPTION

The invention is susceptible to various modifications and alternative forms, and specific embodiments thereof are shown by way of example in the drawings and description. It should be understood, however, that the drawings and description are not intended to limit the invention to the particular form disclosed, but on the contrary, the intention is to cover all modifications, equivalents, and alternatives available to a person having ordinary skill in the art.

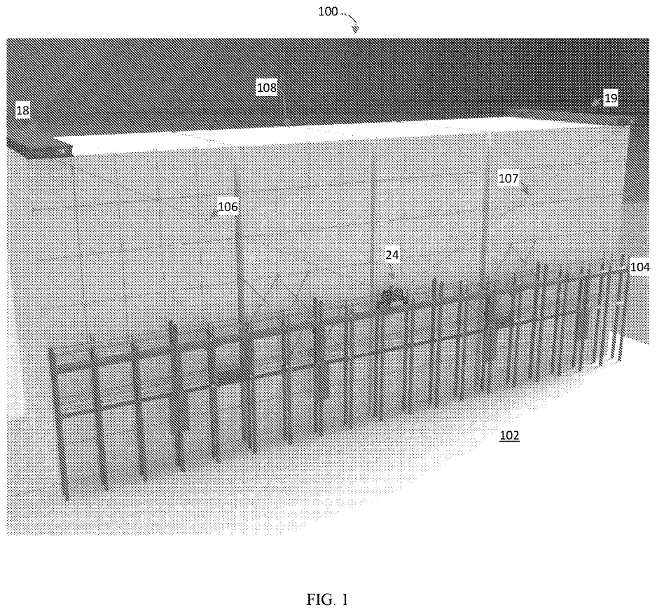

FIGS. 1-6 illustrates a preferred embodiment of a lashing system for deploying a lashing and securing a stack of shipping containers.

FIG. 1 illustrates a cargo ship 100 that has a hatch top or deck 102, on which containers are piled in a stack 108 having several columns. The lashing system includes a tensioning apparatus 24, a winding apparatus 18, a lashing 106, and, optionally, another winding apparatus 19 and another lashing 107. The tensioning apparatus 24 is provided at a location proximate to the middle of the cargo ship 100 between the port side and the starboard side. The tensioning apparatus 24 is adapted to be coupled to a lashing bridge 104 of the cargo ship 100. However, in other embodiments, the tensioning apparatus 24 is adapted to be coupled to the hatch top or deck 102, for example, as is illustrated in U.S. Pat. No. 11,235,841, incorporated herein by reference. As further detailed below, the lashing 106 (and the lashing 107 if provided) is segmented. The winding apparatus 18 and/or 19 is capable of interfacing with an interlocking system of one or more shipping containers stacked in a column of containers.

In other embodiments, the tensioning apparatus 24 may be adapted to be coupled to a hatch top or deck 102 of the cargo ship 100.

In other embodiments, the lashing 107 and the winding apparatus 19 may be coupled to another tensioning apparatus that is offset from the tensioning apparatus 24.

In order to stabilize the shipping containers stored on the cargo ship 100 that are located between a first column of shipping containers stacked at the starboard side of the cargo ship and to which the winding apparatus 18 is coupled, and a second column of shipping containers stacked at the port side of the cargo ship and to which the winding apparatus 19 is coupled, tension is applied to the lashings 106 and 107.

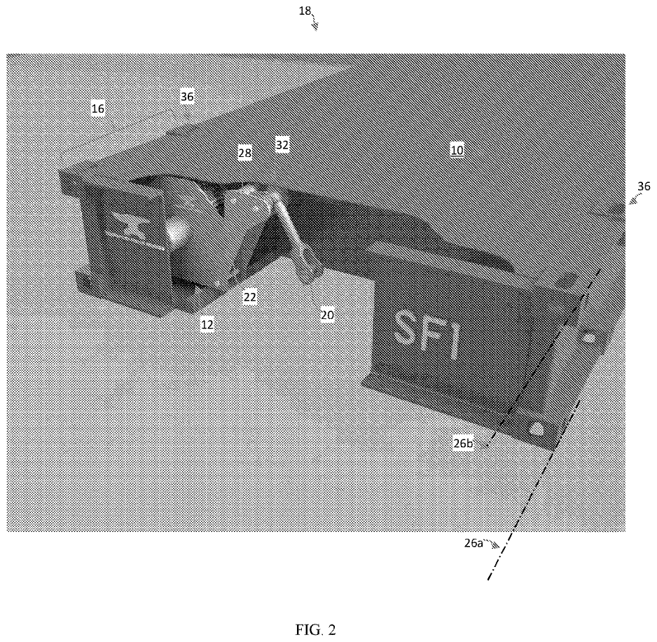

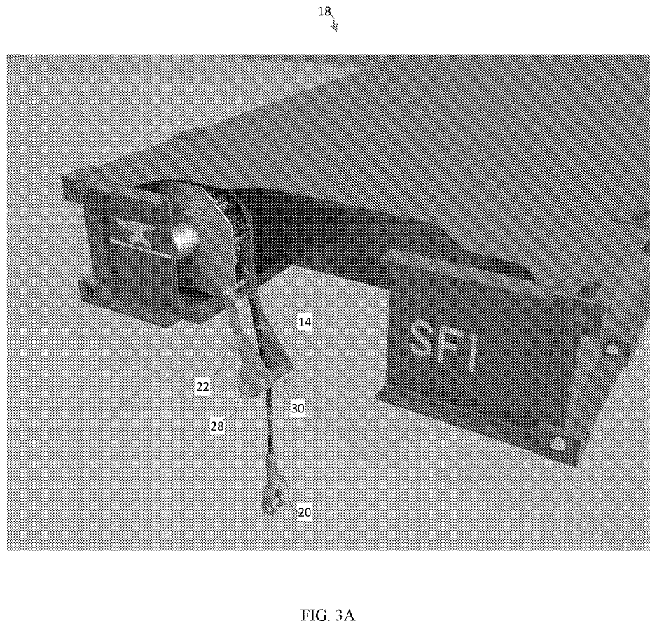

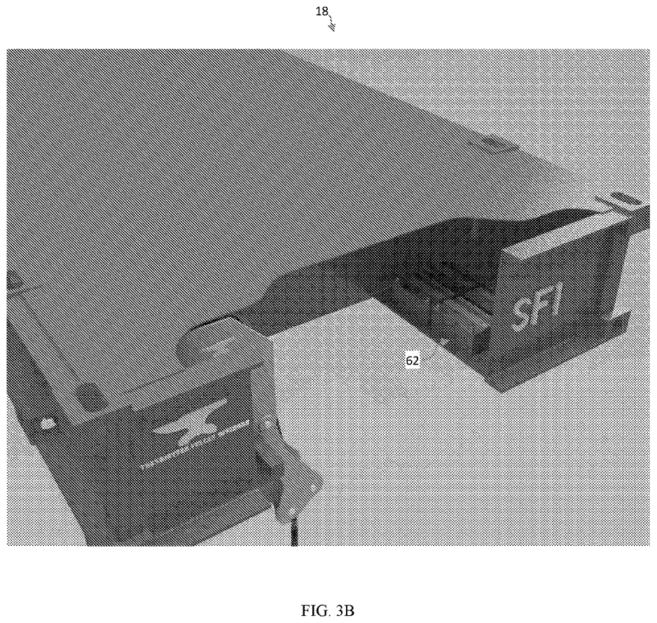

FIGS. 2, 3A and 3B illustrate the winding apparatus 18. The winding apparatus includes a support 10, a motorized winch 12, electronic circuitry configured to drive the motorized winch, a fastening line 14, a releasable connector 20, and a rotatable arm 22. In the preferred embodiment, the support 10 includes a flat rack. The flat rack may be forty-five feet long so that the flat rack has a portion 16 that overhangs a typical forty feet long container when the interlocking systems at locations 36 interface with the typical forty feet long container. The support 10 has a floor level 26a and a ceiling level 26b.

The motorized winch 12 includes a motor coupled to electronic circuitry configured to drive the motorized winch for lifting or lowering the fastening line 14.

The rotatable arm 22 may be coupled, directly or indirectly, to the support 10 and be able to rotate a movable end 28. For example, the rotatable arm 22 may be directly articulated to the motorized winch 12, and the motorized winch 12 may be attached to the support 10. Alternatively, the rotatable arm 22 may be directly articulated to the support 10.

The rotatable arm 22 has a first orientation illustrated in FIG. 2, wherein the rotatable arm 22 is tilted upward. This first orientation is referred to herein as the storage orientation. The rotatable arm 22 has a second orientation illustrated in FIGS. 3A and 3B. This second orientation is referred to herein as the usage orientation. In the storage orientation, the releasable connector 20 is located between the floor level 26a and the ceiling level 26b when the releasable connector 20 is proximal to (e.g., engages or abuts) the movable end 28 of the rotatable arm 22 so that the releasable connector 20 may not interfere with the stacking of containers. In the usage orientation, the fastening line 14 may remain straight when put under tension.

The movable end of the rotatable arm 22 is provided with a roller 30 and/or pulley 32. The roller 30 and the pulley 32 are preferably capable of rotating around their axis. The roller 30 and/or pulley 32 are used to guide the fastening line 14. For example, the fastening line 14 passes between the roller 30 and the pulley 32. The fastening line 14 rests on the pulley 32. In other embodiments, the positions of the roller 30 and the pulley 32 are inversed and the fastening line 14 may rest on the roller 30. In other embodiments, one of the roller 30 and/or pulley 32 (the one at the top) may be omitted. In other embodiments, one of the roller 30 and/or pulley 32 (the one at the top) may not be capable of rotating around its axis.

In the preferred embodiment, the motorized winch 12 includes an electric motor which is coupled to the battery 62 (in FIG. 3B).

The winding apparatus 19 is preferably a mirror image of the winding apparatus 18 shown in FIGS. 2, 3A, and 3B.

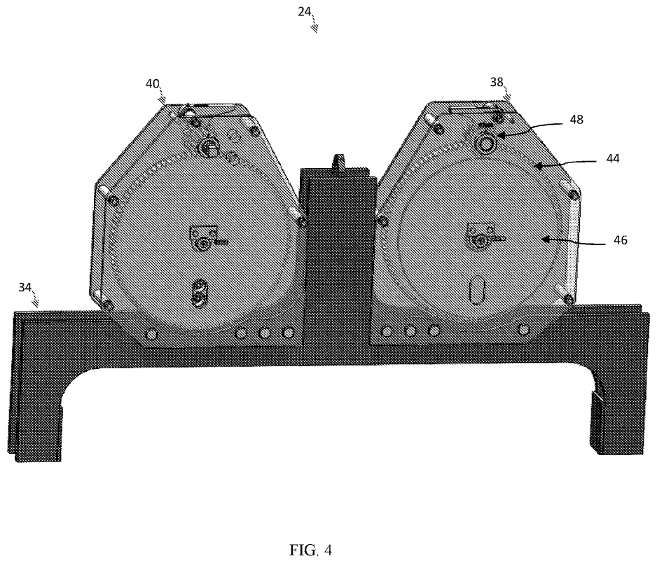

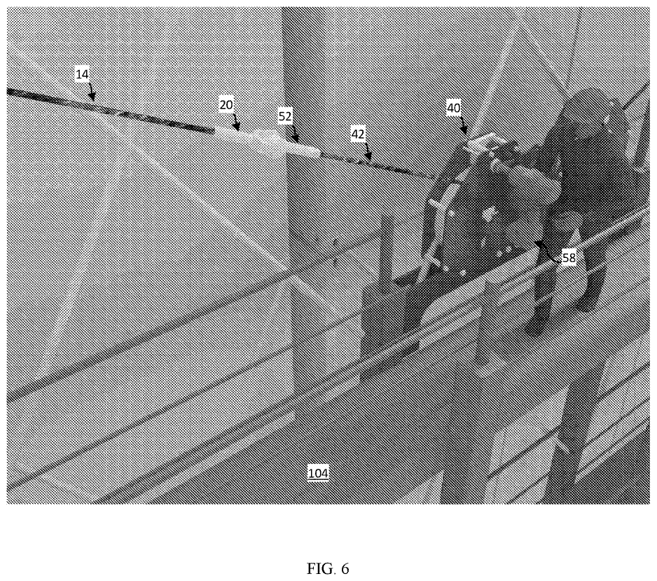

FIGS. 4, 5 and 6 illustrate the tensioning apparatus 24. The tensioning apparatus 24 includes a foundation or mount 34, a tensioning winch 40, and optionally a tensioning winch 38 which is similar to the tensioning winch 40 but rotated half a turn. The tensioning apparatus 24 further includes a tensioning line 42 (in FIG. 6), and another releasable connector 52 (also in FIG. 6).

The tensioning winch 40 includes a reel 46 rotatively coupled to a frame. The tensioning line 42 is attached to the reel 46. The releasable connector 52 is attached to the tensioning line 42.

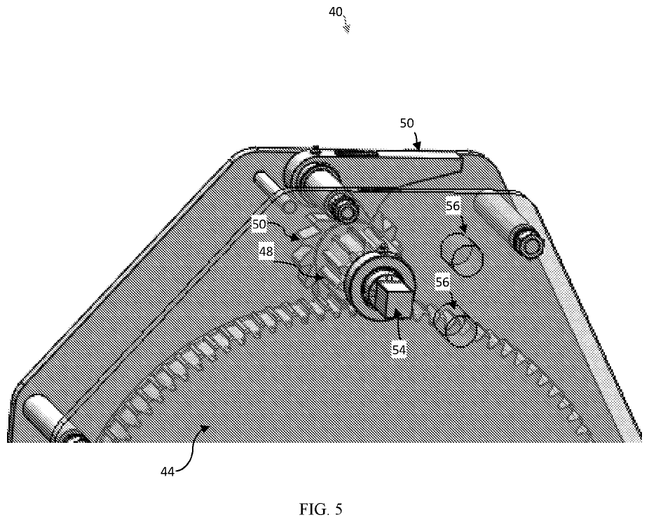

The reel 46 is attached to a first gear 44. The first gear 44 engages a second gear 48. The second gear 48 is attached to a shaft having a pin 54 (e.g., a square pin). The pin 54 is used to drive the tensioning winch 40. The pin 54 can be rotated using a power tool 58 (in FIG. 5) that engages the pin 54 with a socket.

The second gear 48 is coupled to a ratcheting mechanism 50, which is attached to the frame of the tensioning winch 40. The ratcheting mechanism 50 is capable of locking the tensioning winch 40 and prevent the paying out of the tensioning line 42. The ratcheting mechanism 50 allows the paying out of the tensioning line 42. The ratcheting mechanism 50 may be used to hold the tension in a lashing including the fastening line 14 and the tensioning line 42 after the lashing was put under tension.

The power tool 58 connects to reactions points 56 and pin 54 of the tensioning winch 40. It is portable by an operator. The power tool 58 has an electric motor that can be used to put the tensioning line 42 under tension. The motor can also be used to cause the second gear 48 to disengage the ratcheting mechanism 50 and allow the controllable release of the tension in the tensioning line.

Referring back to FIG. 1, with various configurations of the stack 108, the height of the first (i.e., leftmost) column varies. When the winding apparatus 18 is coupled to the top of the first column, it can be seen that the span of the lashing 106 varies as a consequence. In order to accommodate this variation, the lashing 106 is segmented, and includes the fastening line 14 that has a standard, fixed length, and the connection line 42 that also has a standard length that is sufficient to accommodate the variation. Refence herein to a “connection line”, which is attached to the tensioning winch employed in the lashing system and methods of the disclosure, is also referred to herein as a “tensioning line”.

In use, the fastening line 14 is fully paid out. The fastening line 14 is sufficiently long to be reachable by an operator standing the lashing bridge 104 of the cargo ship 100, regardless of the height (within a practical range) of the first column of container. However, the fastening line is too short for directly reaching the tensioning apparatus 24.

Then, the releasable connector 20 of the fastening line 14 is connected, directly or indirectly, to the releasable connector 52 of the tensioning line 42. The fastening line 14 and the tensioning line 42 form the lashing 106. Preferably, the fastening line 14 and the tensioning line 42 are aligned when put under tension such that the lashing 106 is substantially straight and under an uniform tension. The releasable connector and the other releasable connector may be of any known type.

Then, the adjustment for the height of the first column is made up by paying in the tensioning winch mounted in the tensioning apparatus 24, and the lashing 106 is put under tension.

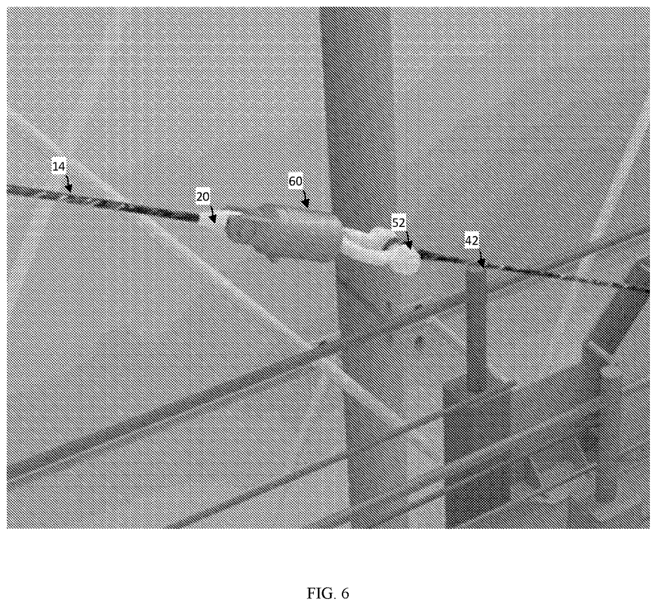

FIG. 7 illustrates a tension monitor 60 that can be interposed between the fastening line 14 and the tensioning line 42.

In use, the fastening line 14 is paid out by the motorized winch 12 and the length adjustment of the lashing 106 is made by paying in the connection line 42. Tension may be applied to the fastening line using the connection line and the tensioning winch. Thus, the tension in the lashing 106 may not be limited by any braking capability of the motorized winch 12 (typically negligible when a braking mechanism is not provided, which is preferred) and the tension may reach the strength of the fastening line. One advantage of omitting a braking mechanism in the motorized winch 12 may be the compact footprint of the motorized winch 12, simplifying its implementation on a winding apparatus configured to be coupled with containers, typically at the top of a column of stacked container.

A winding apparatus 18 with such a compact motorized winch 12 may be easier to deliver to the top of the column with a crane, and without the assistance of an operator at the top of the column. Another advantage of omitting a braking mechanism may be the resulting simplicity of the automated driving of the motorized winch 12, as the winch may only be required to fully pay out the fastening line 14 of a well determined length without real-time adjustment.

The fastening line 14 is sufficiently stiff to withhold tension caused by the movements of the shipping containers.

In addition to the foregoing, the disclosure also contemplates at least the following Embodiments 1 to 1.31, 2 to 2.13, and 3 to 3.08. It should be noted that any element of these embodiments may further include details related to this element that are disclosed in a paragraph or Figure describing the preferred embodiments without including details of other elements that are disclosed in the same or other paragraph or Figure.

Embodiment 1 is a winding apparatus for deploying a lashing on cargo ships and securing shipping containers, comprising: a support capable of interfacing with an interlocking system of one or more shipping containers interface with the support at a top level or a bottom level of the support, the top level and the bottom level being parallel, wherein the support includes an overhang portion that is configured to hang over a longitudinal end of the one or more shipping containers when the interlocking system interfaces with the one or more shipping containers, the overhang portion being located between the bottom level and the top level; a motorized winch attached to the overhang portion and located between the bottom level and the top level; a fastening line attached to the motorized winch; electronic circuitry configured to drive the motorized winch for lifting or lowering the fastening line, the electronic circuitry being located between the bottom level and the top level; a releasable connector attached to the fastening line; and optionally an arm rotatively coupled to the overhang portion, the fastening line resting on a movable end of the arm, the arm having a storage orientation wherein the arm is tilted upward such that the releasable connector is located between the bottom level and the top level when the releasable connector is proximal to the movable end of the arm, the arm having a usage orientation wherein the arm is tilted downward.

Embodiment 1.01 is a winding apparatus in accordance with Embodiment 1, wherein fastening line is selected from a cord, a rope, a string, a chain, a cable, or equivalent.

Embodiment 1.02 is a winding apparatus in accordance with Embodiment 1 or Embodiment 1.01, wherein the fastening line is made of strands that are twisted together.

Embodiment 1.03 is a winding apparatus in accordance with Embodiment 1.02, wherein the strands are made of fibers or wires.

Embodiment 1.04 is a winding apparatus in accordance with any one of Embodiments 1 to 1.03, wherein the support is capable of interfacing with an interlocking system of one or more shipping containers using twist-lock mechanisms.

Embodiment 1.05 is a winding apparatus in accordance with any one of Embodiments 1 to 1.04, wherein the support interfaces with the shipping containers at a top level (or the ceiling level) of the support, with one or more shipping containers located above the support.

Embodiment 1.06 is a winding apparatus in accordance with any one of Embodiments 1 to 1.04, wherein the support interfaces with the shipping containers at a bottom level (or the floor level) of the support, with one or more shipping containers located below the support.

Embodiment 1.07 is a winding apparatus in accordance with any one of Embodiments 1 to 1.06, wherein the support includes a flat rack.

Embodiment 1.08 is a winding apparatus in accordance with Embodiment 1.07, wherein the support includes a forty-five feet long flat rack and is coupled to a standard forty feet long container or two standard twenty feet long containers.

Embodiment 1.09 is a winding apparatus in accordance with any one of Embodiments 1 to 1.08, wherein the overhang portion is located between the bottom level and the top level, in order to not interfere with the stacking of containers.

Embodiment 1.10 is a winding apparatus in accordance with any one of Embodiments 1 to 1.09, wherein an end of the fastening line is attached to a reel of the motorized winch.

Embodiment 1.11 is a winding apparatus in accordance with Embodiment 1.10, wherein the releasable connector is attached to the opposite end of the fastening line to that attached to the motorized winch.

Embodiment 1.12 is a winding apparatus in accordance with any one of Embodiments 1 to 1.11, wherein the lashing is partially formed by the fastening line, and includes another releasable connector attached to a connection line.

Embodiment 1.13 is a winding apparatus in accordance with Embodiment 1.12, wherein the releasable connection attached to the fastening line and the attachment of the fastening line to the motorized winch can hold a tension at least up to the strength of the fastening line.

Embodiment 1.14 is a winding apparatus in accordance with any one of Embodiments 1 to 1.13, wherein the arm which is rotatively coupled to the overhang portion is present.

Embodiment 1.15 is a winding apparatus in accordance with Embodiment 1.14, wherein the rotatable arm is coupled directly to the support and able to rotate a movable end.

Embodiment 1.16 is a winding apparatus in accordance with Embodiment 1.15, wherein the rotatable arm is directly articulated to the support.

Embodiment 1.17 is a winding apparatus in accordance with Embodiment 1.14, wherein the rotatable arm is coupled indirectly to the support and able to rotate a movable end.

Embodiment 1.18 is a winding apparatus in accordance with Embodiment 1.17, wherein the rotatable arm is directly articulated to the motorized winch, and the motorized winch is attached to the support.

Embodiment 1.19 is a winding apparatus in accordance with any one of Embodiments 1.14 to 1.17, wherein the movable end of the rotatable arm is provided with a roller and/or pulley used to guide the fastening line.

Embodiment 1.20 is a winding apparatus in accordance with Embodiment 1.19, wherein the fastening line passes between a roller and a pulley provided at the movable end of the arm.

Embodiment 1.21 is a winding apparatus in accordance with Embodiment 1.19 or Embodiment 1.20, wherein the roller and the pulley are capable of rotating around their axis.

Embodiment 1.22 is a winding apparatus in accordance with any one of Embodiments 1.19 to 1.21, wherein the fastening line rests on the pulley.

Embodiment 1.23 is a winding apparatus in accordance with any one of Embodiments 1.19 to 1.21, wherein the fastening line rests on the roller.

Embodiment 1.24 is a winding apparatus in accordance with Embodiment 1.19, wherein one of the roller and pulley (the one at the top) is omitted.

Embodiment 1.25 is a winding apparatus in accordance with Embodiment 1.19, wherein one of the roller and pulley (the one at the top) is not capable of rotating around its axis.

Embodiment 1.26 is a winding apparatus in accordance with any one of Embodiments 1 to 1.25 further comprising a tension monitor.

Embodiment 1.27 is a winding apparatus in accordance with Embodiment 1.26, wherein the tension monitor includes a housing in which a sensor and its associated electronics, a wireless data emitter or transceiver, and a battery is provided.

Embodiment 1.28 is a winding apparatus in accordance with Embodiment 1.26 or Embodiment 1.27, wherein the tension monitor includes a first releasable connector coupled to the releasable connector attached to the fastening line, the tension monitor further including a second releasable connector, for example, at an end of the tension monitor opposite to the end where the first releasable connector is.

Embodiment 1.29 is a winding apparatus in accordance with Embodiment 1.28, wherein the second releasable connector is coupled to the other releasable connector attached to the connection line.

Embodiment 1.30 is a winding apparatus in accordance with any one of Embodiments 1.01 to 1.29, wherein the motorized winch includes an electric motor coupled to a battery.

Embodiment 1.31 is a winding apparatus in accordance with Embodiment 1.30, wherein the battery is located in the overhang portion and between the bottom level and the top level of the support (in order to not interfere with the stacking of containers).

Embodiment 2 is a lashing system for deploying a lashing on cargo ships and securing shipping containers, comprising: a winding apparatus including: a support capable of interfacing with an interlocking system of one or more shipping containers, wherein the support includes an overhang portion that is configured to hang over a longitudinal end of the one or more shipping containers when the interlocking system interfaces with the one or more shipping containers; a motorized winch attached to the support; a fastening line attached to the motorized winch; electronic circuitry configured to drive the motorized winch for lifting or lowering the fastening line; a first releasable connector attached to the fastening line; and either of: i) a tensioning apparatus including: a foundation, wherein the foundation is adapted to be coupled to at least one of a lashing bridge or a deck of the cargo ship; a tensioning winch attached to the foundation; a connection line attached to the tensioning winch; a second releasable connector attached to the connection line; wherein the first releasable connector is selectively couplable to the second releasable connector; or ii) rigging equipment previously existing on the cargo ship for applying tension to the fastening line.

Embodiment 2.01 is a lashing system for deploying a lashing on cargo ships and securing shipping containers comprising a winding apparatus in accordance with any of embodiments 1 to 1.31 and either of: i) a tensioning apparatus adapted to releasably couple the lashing apparatus to at least one of a lashing bridge or a deck of the cargo ship to apply tension to the fastening line; or ii) rigging equipment previously existing on the cargo ship for applying tension to the fastening line.

Embodiment 2.02 is a system in accordance with Embodiment 2.01 wherein the tensioning apparatus includes: a foundation, wherein the foundation is adapted to be coupled to at least one of a lashing bridge or a deck of the cargo ship; a tensioning winch attached to the foundation; a connection line attached to the tensioning winch; a second releasable connector attached to the connection line; wherein the first releasable connector is selectively couplable to the second releasable connector.

Embodiment 2.03 is a system in accordance with Embodiment 2 or Embodiment 2.02, wherein the tensioning winch is detachable from the foundation, for example, in order to service or replace the tensioning winch.

Embodiment 2.04 is a system in accordance with any one of Embodiments 2, 2.02 or 2.03, wherein the connection line is at least one of: a) lighter than the fastening line; b) not lighter than the fastening line; c) of smaller diameter than the fastening line; d) not of smaller diameter than the fastening line; e) less stiff than the fastening line; and f) not less stiff than the fastening line.

Embodiment 2.05 is a system in accordance with any one of Embodiments 2, and 2.02 to 2.04, wherein the tensioning winch comprises a ratcheting mechanism capable of locking the tensioning winch and preventing the paying out of the tensioning line.

Embodiment 2.06 is a system in accordance with any one of Embodiments 2, and 2.02 to 2.05, further comprising a portable power tool that includes a socket configured to connect to the tensioning winch, drive the tensioning winch to apply tension to a lashing including the fastening line coupled to the tensioning line, and disconnect from the tensioning winch.

Embodiment 2.07 is a system in accordance with Embodiments 2.06, wherein the portable power tool is also capable of driving the tensioning winch to controllably release tension in the lashing.

Embodiment 2.08 is a system in accordance with Embodiment 2.07 wherein the tensioning winch includes a reel rotatively coupled to a frame of the tensioning winch to which the tensioning line is attached, the reel is attached to a first gear which engages a second gear, the second gear is attached to a shaft having a pin used to drive the tensioning winch, wherein the pin is rotatable using the power tool which engages the pin.

Embodiment 2.09 is a system in accordance with Embodiment 2.08 wherein the power tool engages the pin with a socket.

Embodiment 2.10 is a system in accordance with Embodiment 2.09, wherein the second gear is coupled to a ratcheting mechanism capable of locking the tensioning winch and preventing the paying out of the tensioning line, wherein the ratcheting mechanism is attached to the frame of the tensioning winch.

Embodiment 2.11 is a system in accordance with any one of Embodiments 2 to 2.10, wherein the system comprises two or more winding apparatuses, each as described in any one of Embodiments 1 to 1.31 or 2.

Embodiment 2.12 is a system in accordance with Embodiment 2.11, wherein the system comprises two winding apparatuses coupled to a single tensioning apparatus as described herein or coupled to two tensioning apparatuses as described herein which are offset from each other.

Embodiment 2.13 is a system in accordance with Embodiment 2.12 wherein the two winding apparatuses are arranged to occupy mirror image positions of each other on separate side stacks of shipping containers (e.g. located at port and starboard sides of the cargo ship).

Embodiment 3 is a method of deploying a lashing on cargo ships and securing shipping containers, comprising: providing a winding apparatus including a support, a motorized winch attached to the support, a fastening line attached to the motorized winch, a first releasable connector attached to the fastening line, and electronic circuitry configured to drive the motorized winch; interfacing the support with an interlocking system of one or more shipping containers, wherein the support includes an overhang portion that is configured to hang over a longitudinal end of the one or more shipping containers when the interlocking system interfaces with the one or more shipping containers; providing a tensioning apparatus including a foundation, a tensioning winch attached to the foundation, a connection line attached to the tensioning winch, and a second releasable connector attached to the connection line; coupling the foundation to at least one of a lashing bridge or a deck of the cargo ship; paying out the fastening line fully; coupling the connection line to the fastening line using the first and second releasable connectors; and applying tension to the fastening line by paying in the connection line with the tensioning winch.

Embodiment 3.01 is a method in accordance with Embodiment 3, wherein the winding apparatus is as defined in any one of Embodiments 1 to 1.31.

Embodiment 3.02 is a method in accordance with Embodiment 3 and 3.01, wherein the method comprises the step of providing a lashing system in accordance with any one of Embodiments 2 to 2.13.

Embodiment 3.03 is a method in accordance with any one of Embodiments 3 to 3.02, wherein the tensioning winch comprises a ratcheting mechanism, the method further comprising the step of holding the tension applied to the fastening line via the tensioning line using the ratcheting mechanism.

Embodiment 3.04 is a method in accordance with any one of Embodiments 3 to 3.03, further comprising the step of providing a portable power tool that includes a socket configured to connect to the tensioning winch, drive the tensioning winch, and disconnect from the tensioning winch, wherein applying the tension to the fastening line is performed using the portable power tool.

Embodiment 3.05 is a method in accordance with Embodiment 3.04 further comprising the step of controllably releasing the tension in the fastening line using the portable power tool.

Embodiment 3.06 is a method in accordance with any one of Embodiments 3 to 3.05, wherein, when the support interfaces with a top container of a side stack of containers, the foundation is coupled to the at least one of the lashing bridge or the deck of the cargo, and the fastening line is fully paid out, and wherein:
(i) the fastening line is sufficiently long to be reachable by an operator standing on the one of the lashing bridge or the deck of the cargo ship, and
(ii) the fastening line is too short for directly reaching the tensioning winch so that the tensioning line can be reeled in to apply tension to the fastening line.

Embodiment 3.07 is a method in accordance with any one of Embodiments 3 to 3.06, wherein the side stack of containers is located at one side (e.g. the starboard side) of the cargo ship, wherein the tensioning winch is coupled substantially in the middle of the at least one of the lashing bridge or the deck of the cargo ship, another tensioning winch is attached, directly or indirectly, to the foundation next to the tensioning winch, another connection line attached to the other tensioning winch and to yet another releasable connector, and the method further comprising the steps of deploying another fastening line, attaching the other fastening line to the other tensioning line, and applying tension to the other fastening line by reeling in the other lashing to secure another stack of containers located at an opposing side (e.g. the port side) of the cargo ship to the other stack of containers.

Embodiment 3.08 is a method in accordance with Embodiment 3.07, wherein, the other fastening line is deployed using a winding apparatus as described in any one of Embodiments 1 to 1.31.

1. A winding apparatus for deploying a lashing on cargo ships and securing shipping containers, comprising:
a support capable of interfacing with an interlocking system of one or more shipping containers interface with the support at a top level or a bottom level of the support, the top level and the bottom level being parallel, wherein the support includes an overhang portion that is configured to hang over a longitudinal end of the one or more shipping containers when the interlocking system interfaces with the one or more shipping containers, the overhang portion being located between the bottom level and the top level;
a motorized winch attached to the overhang portion and located between the bottom level and the top level;
a fastening line attached to the motorized winch;
electronic circuitry configured to drive the motorized winch for lifting or lowering the fastening line, the electronic circuitry being located between the bottom level and the top level;
a releasable connector attached to the fastening line; and
an arm rotatively coupled to the overhang portion, the fastening line resting on a movable end of the arm, the arm having a storage orientation wherein the arm is tilted upward such that the releasable connector is located between the bottom level and the top level when the releasable connector is proximal to the movable end of the arm, the arm having a usage orientation wherein the arm is tilted downward.

2. The winding apparatus of claim 1, further comprising a tension monitor, the tension monitor including a first releasable connector coupled to the releasable connector attached to the fastening line, the tension monitor further including a second releasable connector.

3. The winding apparatus of claim 2, wherein the tension monitor includes a battery and a wireless data emitter or transceiver.

4. The winding apparatus of claim 1, wherein the motorized winch includes an electric motor coupled to a battery, wherein the battery is located in the overhang portion and between the top level and the bottom level.

5. The winding apparatus of claim 1, wherein the movable end of the arm is provided with a roller or pulley.

6. The winding apparatus of claim 1, wherein the fastening line passes between a roller and a pulley provided at the movable end of the arm.

7-10. (canceled)

11. The method of claim 14 wherein the tensioning winch comprises a ratcheting mechanism, the method further comprising holding the tension applied to the fastening line via the tensioning line using the ratcheting mechanism.

12-13. (canceled)

14. A method of deploying a lashing on cargo ships and securing shipping containers, comprising:
providing a winding apparatus including a support, a motorized winch attached to the support, a fastening line attached to the motorized winch, a first releasable connector attached to the fastening line, and electronic circuitry configured to drive the motorized winch;
interfacing the support with an interlocking system of one or more shipping containers, wherein the support includes an overhang portion that is configured to hang over a longitudinal end of the one or more shipping containers when the interlocking system interfaces with the one or more shipping containers;
providing a tensioning apparatus including a foundation, a tensioning winch attached to the foundation, a connection line attached to the tensioning winch, and a second releasable connector attached to the connection line;
coupling the foundation to at least one of a lashing bridge or a deck of the cargo ship;
paying out the fastening line fully;
coupling the connection line to the fastening line using the first and second releasable connectors; and
applying tension to the fastening line by paying in the connection line with the tensioning winch, wherein, when the support interfaces with a top container of a side stack
of containers, the foundation is coupled to the at least one of the lashing bridge or the deck of the cargo, and the fastening line is fully paid out,
the fastening line is sufficiently long to be reachable by an operator standing on the one of the lashing bridge or the deck of the cargo ship, and
the fastening line is too short for directly reaching the tensioning winch.

15. A method of deploying a lashing on cargo ships and securing shipping containers, comprising:
providing a winding apparatus including a support, a motorized winch attached to the support, a fastening line attached to the motorized winch, a first releasable connector attached to the fastening line, and electronic circuitry configured to drive the motorized winch;
interfacing the support with an interlocking system of one or more shipping containers, wherein the support includes an overhang portion that is configured to hang over a longitudinal end of the one or more shipping containers when the interlocking system interfaces with the one or more shipping containers;
providing a tensioning apparatus including a foundation, a tensioning winch attached to the foundation, a connection line attached to the tensioning winch, and a second releasable connector attached to the connection line;
coupling the foundation to at least one of a lashing bridge or a deck of the cargo ship;
paying out the fastening line fully;
coupling the connection line to the fastening line using the first and second releasable connectors;
applying tension to the fastening line by paying in the connection line with the tensioning winch;
providing a portable power tool that includes a socket configured to connect to the tensioning winch, drive the tensioning winch, and disconnect from the tensioning winch, wherein applying the tension to the fastening line is performed using the portable power tool; and
controllably releasing the tension in the fastening line using the portable power tool.
wherein the side stack of containers is located at a starboard side of the cargo ship,
wherein the foundation is coupled substantially in a middle of the at least one of the lashing bridge or the deck of the cargo ship;
wherein the tensioning apparatus includes another tensioning winch attached to the foundation, another connection line attached to the other tensioning winch, and another second releasable connector;
the method further comprising:
deploying another fastening line and securing another stack of containers located at a port side of the cargo ship;
coupling the other connection line to the other fastening line; and
applying tension to the other fastening line by reeling in the other connection line with the other tensioning winch.
